(19) United States
(12) Patent Application Publication
(10) Pub. No.: US 2011/0173020 A1
(43) Pub. Date: Jul. 14, 2011

(54) Safeguard System in the Prescription and Dispensing of Drugs

(75) Inventors: Kenneth Stephen Bailey, San Jose, CA (US); Paul Salvador Mula, San Jose, CA (US)

(73) Assignee: CLEAR VIEW TECHNOLOGY, INC

(21) Appl. No.: 12/964,740

(22) Filed: Dec. 10, 2010

Related U.S. Application Data
(60) Provisional application No. 61/284,482, filed on Dec. 14, 2009.

(51) Int. Cl. G06Q 50/00; G06K 9/68

(52) U.S. Cl. 705/2; 382/218

(57) ABSTRACT

The world was shocked at the untimely death of Michael Jackson, a Rock and Roll Legend in the World of Music. This demonstrates how easy access to habit forming drugs and celebrity status contributed to his sudden death. A prescription is used to administer a prescription drug to a patient. This printed prescription is encrypted with a cipher glyph that has the patient's name, drug prescribed, dosage and doctor's name and registration number graphically hidden in the prescription itself. The prescription when presented to the pharmacy for dispensing is inserted into a machine which verifies and authenticates the prescription and other embedded information. The encrypted information is sent to a central server database to log and record the data.

This application claims priority from provisional application No. 61/284,482, filed Dec. 14, 2010, the entire contents of which are herewith incorporated by reference.

### BACKGROUND

Since the dawn of humankind, mixtures of animal parts, plants and minerals to treat wounds, sores and ailments evolved from rudimentary pharmacological compounds into more sophisticated experiments to create medical treatments. Egypt first documented herbal amalgams for healing. Archives of ancient Greek texts reveal the extent of their medicinal knowledge of herbal mixtures. Chinese and Arab peoples advanced pharmacology research of herbal and mineral benefits for medical treatments as well. Early in the 20th century, modern pharmacology emerged with the first synthetic compound created in Europe.

A prescription (Rx) is a health-care program implemented by a physician or other medical practitioner in the form of instructions that govern the plan of care for an individual patient. Prescriptions may include orders to be performed by a patient, caretaker, nurse, pharmacist or other therapist. Commonly, the term prescription is used to mean an order to take certain medications. Prescriptions have legal implications, as they may indicate that the prescriber takes responsibility for the clinical care of the patient and in particular for monitoring efficacy and safety. However, as medications have increasingly become pre-packaged manufactured products and medical practice has become more complex, the scope of meaning of the term “prescription” has broadened to also include clinical assessments, laboratory tests, and imaging studies relevant to optimizing the safety or efficacy.

Prescriptions are handwritten on preprinted prescription forms that are assembled into pads, or alternatively printed onto similar forms using a computer printer. Preprinted on the form is text that identifies the document as a prescription, the name and address of the prescribing provider and any other legal requirement such as a registration number (e.g. DEA Number in the United States). Unique for each prescription is the name of the patient. In the United Kingdom, the patient's name and address must also be recorded. Each prescription is dated and some jurisdictions may place a time limit on the prescription. There is the specific “recipe” of the medication and the directions for taking it.

Both pharmacists and prescribers are regulated professions in most jurisdictions. A prescription as a communications mechanism between them is also regulated and is a legal document.

Regulations may define what constitutes a prescription, the contents and format of the prescription how prescriptions are handled and stored by the pharmacist. Many jurisdictions will now allow faxed or phone prescriptions containing the same information.

Drug companies use direct-to-prescriber advertising in an effort to convince prescribers to dispense as written with brand-name products rather than generic drugs.

Many brand name drugs have less expensive generic drug substitutes that are therapeutically equivalent. Prescriptions will also contain instructions on whether the prescriber will allow the pharmacist to substitute a generic version of the drug. This instruction is communicated in a number of ways.

In some jurisdictions, the preprinted prescription contains two signature lines: one line has “dispense as written” printed underneath; the other line has “substitution permitted” underneath. Some have a preprinted box “dispense as written” for the prescriber to check off (but this is easily checked off by anyone with access to the prescription). Other jurisdictions the protocol is for the prescriber to handwrite one of the following phrases: “dispense as written”, “DAW”, “brand necessary”, “do not substitute”, “no substitution”, “medically necessary”, “do not interchange”. In other jurisdictions may they use completely different languages. In some jurisdictions, it may be a legal requirement to include the age of child on the prescription. For pediatric prescriptions, some advise the inclusion of the age of the child if the patient is less than twelve and the age and months if less than five. (In general, including the age on the prescription is helpful.) Adding the weight of the child is also helpful.

Prescriptions often have a “label” box. When checked, pharmacist is instructed to label the medication. When not checked, the patient only receives instructions for taking the medication and no information about the prescription itself.

Some prescribers further inform the patient and pharmacist by providing the indicator for the medication; i.e. what is being treated. This assists the pharmacist in checking for errors as many common medications can be used for multiple medical conditions.

Some prescriptions will specify whether and how many “repeats” or “refills” are allowed; that is whether the patient may obtain more of the same medication without getting a new prescription from the medical practitioner. Regulations may restrict some types of drugs from being refilled.

In group practices, the preprinted portion of the prescription may contain multiple prescribers' names. Prescribers typically circle themselves to indicate who is prescribing or there may be a checkbox next to their name.

When filled by a pharmacist, as a matter of business practice, the pharmacist may write certain information right on the prescription. This may also be mandated by legislation (see Exhibit D). Information such as the actual manufacturer of the drug and the date the medication was dispensed may be written right onto the prescription. Legislation may require the pharmacist sign the prescription. In computerized pharmacies, all such information is printed and stapled to the prescription. Sometimes such information is printed onto labels and the labels affixed right onto the prescription.

When filled by the pharmacist, prescriptions are typically assigned a “prescription number” (often abbreviated “Rx#” in the US) that is unique to the pharmacy that filled the prescription. The prescription number is written right on the prescription by the pharmacist. The prescription number has the practical purpose of uniquely identifying the prescription later on while filed (both manual and electronic). The prescription number is also put on the label on the dispensed medication. The patient may be required to reference the prescription number for refills and drug insurance claims. There may also be a legal requirement for prescription numbers for subsequent identification purposes.

As a legal document, some jurisdictions will mandate the archiving of the original paper prescription in the pharmacy. Often the patient cannot take the original prescription with them. Some jurisdictions may entitle patients to a copy. The retention period varies but can be as long as six years. See Exhibit B for sample legislation governing the archiving of prescriptions. Once the retention period has passed, privacy legislation may dictate what can be done with the original paper prescription. Legislation may also dictate what happens to the prescriptions if the pharmacy closes or is sold. For example, if the pharmacy goes out of business, the pharmacist may be required to return the prescription to the patient, to the next closest pharmacy or to the governing body for pharmacists.

Prescriptions for non-narcotic drugs may also be “transferred” from one pharmacy to another for subsequent repeats to be dispensed from another pharmacy. The physical piece of paper that is the prescription is not transferred, but all the information on it is transferred from one pharmacy to another. Legislation may dictate the protocol by which the transfer occurs and whether the transfer needs to be noted on the original paper prescription.

It is estimated that 3 billion (3 thousand million) prescriptions were written in the United States in 2002. This number has grown from 1.5 billion in 1989 and is expected to continue to grow.

Prescriptions are sometimes forged because many narcotics are cheaper and safer as prescription drugs than as street drugs. Forgery takes many forms: Prescription pads are sometimes stolen, amounts may be altered on legitimate prescriptions, call back numbers may be falsified and phoned or faxed prescriptions faked.

Some medical practitioners will use prescription pads that contain similar security measures as checks to make photocopying prescriptions harder. These security measures may be mandated by lawLegislation may mandate that only certain printers may print prescriptions. New Jersey, for example, requires that only state approved printers may be used to print official “New Jersey Prescription Blanks.” Prescribers can make it harder for amount forgeries by writing out the amounts in words. Again, this may be mandated by law.

Some jurisdictions help control stolen prescriptions by requiring special “triplicate prescriptions” for certain classes of drugs. Blank triplicates are only available from the regulating agency and are individually numbered. The medical practitioner retains a copy, the second and third copies are given to the patient to give to the pharmacist. The pharmacist retains the second copy and the third copy is submitted to the regulating agency. The regulating agency can issue lists of forged prescriptions that pharmacists can check. In this example, the prescription's validity is further limited to 72 hours from issuance. California has recently replaced triplicate forms with new forms that are impossible to photocopy or fax: the background is printed with repetitions of the word void in a color that shows up as black on a photocopy.

States have various laws making theft of prescription blanks or forgery of prescriptions criminal offenses and/or providing special treatment for these offenses (for Example N J. Stat. 2C:21-1. making forgery of a prescription blank a third degree rather than fourth degree offense).

When forgery is suspected, pharmacists will call the medical practitioner to verify the prescription. Forged prescriptions are no longer considered medical documents and doctor-patient confidentiality rules no longer apply.

Who can issue prescriptions is governed by local legislation. In the United States medical practitioners, veterinarians, dentists, and podiatrists have prescribing power. In addition, clinical pharmacists are allowed to prescribe in some states through the use of a drug formulary or collaboration agreements. In all states, optometrists prescribe medications to treat certain eye diseases, and also issue spectacle and contact lens prescriptions for corrective eyewear. States allow registered certified physician assistants (also known as physician associates or PAs) prescription powers in all 50 states. Several states have passed RxP legislation, allowing clinical psychologists (PhD's or PsyD's) who are registered as medical psychologists and have also undergone specialized training in script-writing to prescribe a limited number of drugs to treat emotional and mental disorders.

Prescriptions, when handwritten, are notorious for being often illegible. In the US, medical practitioners' sloppy handwriting kills more than 7,000 people annually, according to a July 2006 report from the National Academies of Science's Institute of Medicine (IOM). Historically, physicians used Latin words and abbreviations to convey the entire prescription to the pharmacist. Today, many of the abbreviations are still widely used and must be understood to interpret prescriptions. At other times, even though some of the individual letters are illegible, the position of the legible letters and length of the word is sufficient to distinguish the medication based on the knowledge of the pharmacist. When in doubt, pharmacists call the medical practitioner. Some jurisdictions have legislated legible prescriptions (e.g. Florida). Some have advocated the elimination of handwritten prescriptions altogether and computer printed prescriptions are becoming increasingly common in some places.

Over the years, prescribers have developed many conventions for prescription-writing, with the goal of avoiding ambiguities or misinterpretation.

Prescriptions are also used for things that are not strictly regulated as a prescription drug. Prescribers will often give non-prescription drugs out as prescriptions because drug benefit plans may reimburse the patient only if the over-the-counter medication is taken under the direction of a medical practitioner. Conversely, if a medication is available over-the-counter, prescribers may ask patients if they want it as a prescription or purchase it themselves. Pharmacists may or may not be able to price the medication competively with over-the-counter equivalents. If the patient wants the medication not under prescription, the prescriber is usually careful to give the medication name to the patient on a blank piece of paper to avoid any confusion with a prescription. This is applied to non-medications as well. For example, crutches, and registered massage therapy may be reimbursed under some health plans, but only if given out by a prescriber as a prescription.

Prescribers will often use blank prescriptions as general letterhead. Legislation may define certain equipment as “prescription devices”. Such prescription devices can only be used under the supervision of authorized personnel and such authorization is typically documented using a prescription. Examples of prescription devices include dental cement (for affixing braces to tooth surfaces), various prostheses, gut sutures, sickle cell tests, cervical cap and ultrasound monitor.

In some jurisdictions, hypodermic syringes are in a special class of their own, regulated as illicit drug use accessories separate from regular medical legislation. Such legislation will often specify a prescription as the means by which one may legally possess syringes.

Prescriptions may also be used as a short form for prescription drugs to distinguish from over-the-counter drugs. In reference to the entire system of controlling drug distribution (as opposed to illicit drugs), “prescription” is often used as a metaphor for healthy directions from a prescribing medical practitioner. A “green prescription” is direction from a medical practitioner to a patient for exercise and healthy diet.

Pharmacy information systems are a potential source of valuable information for pharmaceutical companies as it contains information about the prescriber's prescribing habits. Prescription data mining of such data is a developing, specialized field.

Many prescribers lack the digitized information systems that reduce prescribing errors. To reduce these errors, some investigators have developed modified prescription forms that prompt the prescriber to provide all the desired elements of a good prescription. The modified forms also contain pre-defined choices such as common quantities, units and frequencies that the prescriber may circle rather than write out. Such forms are thought to reduce errors, especially omission and handwriting errors and are actively under evaluation. (See: Kennedy AG, Littenberg B. A Modified Outpatient Prescription Form to Reduce Prescription Errors. Joint Commission Journal of Quality and Safety 2004; 30:480-487.)

Taken from California's Business and Professions Code Section 4040:

4040. (a) “Prescription” means an oral, written, or electronic transmission order that is both of the following:

(1) Given individually for the person or persons for whom ordered that includes all of the following:

(A) The name or names and address of the patient or patients.

(B) The name and quantity of the drug or device prescribed and the directions for use.

(C) The date of issue.

(D) Either rubber stamped, typed, or printed by hand or typeset, the name, address, and telephone number of the prescriber, his or her license classification, and his or her federal registry number, if a controlled substance is prescribed.

(E) A legible, clear notice of the condition for which the drug is being prescribed, if requested by the patient or patients.

(F) If in writing, signed by the prescriber issuing the order, or the certified nurse-midwife, nurse practitioner, or physician assistant who issues a drug order pursuant to Section 2746.51,2836.1, or 3502.1.

(2) Issued by a prescribing medical practitioner if a drug order is issued pursuant to Section 2746.51,2836.1, or 3502.1.

(b) Notwithstanding subdivision (a), a written order of the prescriber for a dangerous drug, except for any Schedule II controlled substance, that contains at least the name and signature of the prescriber, the name and address of the patient in a manner consistent with paragraph (3) of subdivision (b) of Section 11164 of the Health and Safety Code, the name and quantity of the drug prescribed, directions for use, and the date of issue may be treated as a prescription by the dispensing pharmacist as long as any additional information required by subdivision (a) is readily retrievable in the pharmacy. In the event of a conflict between this subdivision and Section 11164 of the Health and Safety Code, Section 11164 of the Health and Safety Code shall prevail.

(c) “Electronic transmission prescription” includes both image and data prescriptions. “Electronic image transmission prescription” means any prescription order for which a facsimile of the order is received by a pharmacy from a licensed prescriber. “Electronic data transmission prescription” means any prescription order, other than an electronic image transmission prescription, that is electronically transmitted from a licensed prescriber to a pharmacy.

(d) The use of commonly used abbreviations shall not invalidate an otherwise valid prescription.

(e) Nothing in the amendments made to this section (formerly Section 4036) at the 1969 Regular Session of the Legislature shall be construed as expanding or limiting the right that a chiropractor, while acting within the scope of his or her license, may have to prescribe a device.

From the Mississippi Board of Pharmacy:

Article XIII Prescriptions to be Filed

1. All prescriptions shall be filed in one of the following ways:

A. Three separate files may be maintained; a file for Schedule II prescriptions

dispensed; a file for Schedule III, IV and V prescriptions dispensed; and a file for all other prescriptions dispensed.

B. Two files may be maintained; a file for all Schedule II prescriptions dispensed and another file for all other prescriptions dispensed, including those in Schedule III, IV and V. If this method is used, the prescriptions for Schedule III, IV and V substances must be stamped with the letter “C” in red ink, not less than one inch high, in the lower right-hand corner. This distinctive marking makes the records readily retrievable for inspection. Pharmacies with automatic data processing systems are exempted from marking Schedule III, IV and V controlled substance prescriptions with the red “C”.

2. A hard copy of original prescriptions, whether records are maintained manually or in a data processing system, shall be assigned a serial number and maintained by the pharmacy in numerical and chronological order. All prescriptions shall be maintained for at least five years from the date of original dispensing.

3. If a pharmacy utilizes a data processing system for record keeping, all computer generated labels should be affixed to the prescription document in such a manner as not to obscure information on the face of the document.

From Indiana Board of Pharmacy:

Sec. 2. (a) All controlled substance prescriptions written by licensed Indiana practitioners, as defined by IC 16-42-19-5, must contain the following security features:

(1) A latent, repetitive “void” pattern screened at five percent (5%) in reflex blue must appear across the entire face of the document when the prescription is photocopied.

(2) There shall be a custom artificial watermark printed on the back side of the base paper so that it may only be seen at a forty-five (45) degree angle. The watermark shall consist of the words “Indiana Security Prescription”, appearing horizontally in a step-and-repeated format in five lines on the back of the document using 12-point Helvetica bold type style.

(3) An opaque RX symbol must appear in the upper right-hand corner, one-eighth (⅛) of an inch from the top of the pad and five-sixteenths ( 5/16) of an inch from the right side of the pad. The symbol must be three-fourths (¾) inch in size and must disappear if the prescription copy is lightened.

(4) Six (6) quantity check-off boxes must be printed on the form and the

following quantities must appear and the appropriate box be checked off for the prescription to be valid:

(A) 1-24

(B) 25-49

(C) 50-74

(D) 75-100

(E) 101-150

(F) 151 and over.

(5) No advertisements may appear on the front or back of the prescription blank.

(6) Logos, defined as a symbol utilized by an individual, professional practice, professional association, or hospital, may appear on the prescription blank. The upper left one (1) inch square of the prescription blank is reserved for the purpose of logos. Only logos, as defined by this subdivision, may appear on the prescription blank.

(7) Only one (1) prescription may be written per prescription blank. The following statement must be printed on the bottom of the pad: “Prescription is void if more than one (1) prescription is written per blank.”

(8) Refill options that can be circled by the prescriber must appear below any logos and above the signature lines on the left side of the prescription blank in the following order: Refill NR 1 2 3 4 5 Void after —.

(9) Practitioner name and state issued professional license number must be preprinted, stamped, or manually printed on the prescription.

(10) All prescription blanks printed under this rule shall be four and one-fourth (4-¼) inches high and five and one-half (5-½) inches wide.

(b) Nothing in this rule shall prevent licensed Indiana practitioners from utilizing security paper prescriptions for the prescribing of any legend drug. (Indiana Board of Pharmacy; 856 IAC 1-34-2; filed Jul. 5, 1995, 9:45 a.m.: 18 IR 2782, eff Jan. 1, 1996)

Taken from the Ontario's Drug and Pharmacies Regulation Act, paragraph 156.

(1) Every person who dispenses a drug pursuant to a prescription shall ensure that the following information is recorded on the prescription, (a) the name and address of the person for whom the drug is prescribed;

(b) the name, strength (where applicable) and quantity of the prescribed drug; (c) the directions for use, as prescribed; (d) the name and address of the prescriber; (e) the identity of the manufacturer of the drug dispensed; (f) an identification number or other designation;

(g) the signature of the person dispensing the drug and, where different, also the signature of the person receiving a verbal prescription;

(h) the date on which the drug is dispensed;

(i) the price charged.

From New Jersey official statutes:

### 45:14-55 Use of New Jersey Prescription Blanks.

16.a. A practitioner practicing in this State shall use non-reproducible, non-erasable safety paper New Jersey Prescription Blanks bearing that practitioner's license number whenever the practitioner issues prescriptions for controlled dangerous substances, prescription legend drugs or other prescription items. The prescription blanks shall be secured from a vendor approved by the Division of Consumer Affairs in the Department of Law and Public Safety.

b. A licensed practitioner practicing in this State shall maintain a record of the receipt of New Jersey Prescription Blanks. The practitioner shall notify the Office of Drug Control in the Division of Consumer Affairs as soon as possible but no later than 72 hours of being made aware that any New Jersey Prescription Blank in the practitioner's possession has been stolen. Upon receipt of notification, the Office of Drug Control shall take appropriate action, including notification to the Department of Human Services and the Attorney General.

45:14-56 Health care facility prescriptions.

17.a. Prescriptions issued by a health care facility licensed pursuant to P.L.1971, c.136 (C.26:2H-1 et seq.) shall be written on non-reproducible, non-erasable safety paper New Jersey Prescription Blanks. The prescription blanks shall be secured from a vendor approved by the Division of Consumer Affairs in the Department of Law and Public Safety. The New Jersey Prescription Blanks shall bear the unique provider number assigned to that health care facility for the issuing of prescriptions for controlled dangerous substances, prescription legend drugs or other prescription items.

b. A health care facility shall maintain a record of the receipt of New Jersey Prescription Blanks. The health care facility shall notify the Office of Drug Control in the Division of Consumer Affairs as soon as possible but no later than 72 hours of being made aware that any New Jersey Prescription Blank in the facility's possession has been stolen. Upon receipt of notification, the Office of Drug Control shall take appropriate action including notification to the Department of Human Services and the Attorney General.

45:14-57 Requirements for prescription to be filled.

18. A prescription issued by a practitioner or health care facility licensed in New Jersey shall not be filled by a pharmacist unless the prescription is issued on a New Jersey Prescription Blank bearing the practitioner's license number or the unique provider number assigned to a health care facility.

45:14-59 Format for New Jersey Prescription Blanks.

20. The Division of Consumer Affairs in the Department of Law and Public Safety shall establish the format for uniform, non-reproducible, non-erasable safety paper prescription blanks, to be known as New Jersey Prescription Blanks, which format shall include an identifiable logo or symbol that will appear on all prescription blanks. The division shall approve a sufficient number of vendors to ensure production of an adequate supply of New Jersey Prescription Blanks for practitioners and health care facilities statewide. It is clear from the foregoing that even with strict and stringent Government regulations, many procedures are not followed as defined and many careless human errors lead to the patients' undue risks and sometimes death.

### SUMMARY

Embodiments describe a prescription forming and/or reading system that may be used to verify the prescriptions, to keep track of the prescriptions, and also to maintain the central database of such prescriptions.

### BRIEF DESCRIPTION OF THE DRAWINGS

in the drawings:

FIG. 1 depicts the system components in a preferred embodiment.

FIG. 2 depicts the flow chart of steps that can be taken in the present invention to insure proper safeguards and controls in the prescribing, administering and dispensing of certain drugs and controlled substances.

FIG. 3A-3c depicts the cipher glyph pattern example for the encryption and creation of the prescription for deciphering at the pharmacy and the procedure therein.

FIG. 4 depicts the arrangement of the files and reports in the central databse controlled by one or more Government agencies for example.

FIG. 5 depicts the procedure that is followed and report that is generated when the system detects unusual or illegal prescribing, administering or dispensing of drugs or controlled substances for example.

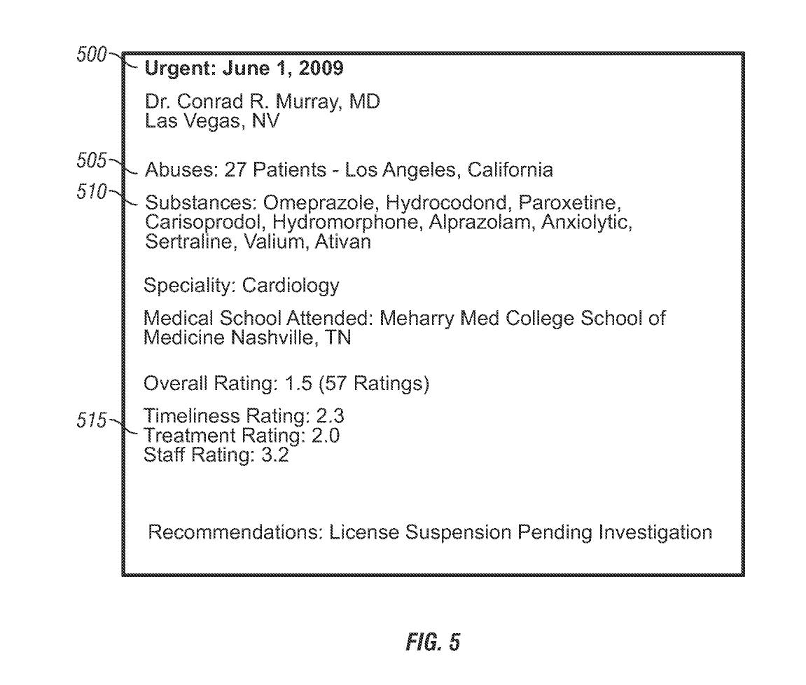

FIG. 6 depicts the notice that will be sent to the prescribing doctor, the administering hospital staff member or dispensing pharmacist if and when illegal or unusual activities are detected in the prescribing of certain drugs or controlled substances for example.

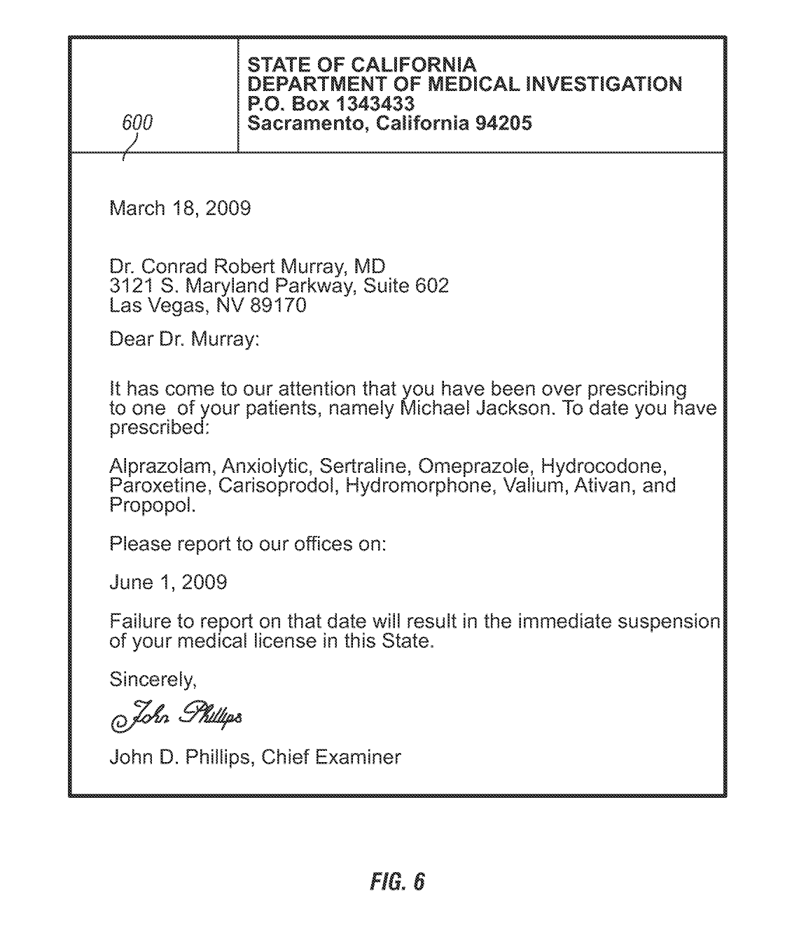

### DETAILED DESCRIPTION

The embodiments address this long felt need as described above. The herein described system when utilized properly can reduce problems in drug distribution.

ClearView technologies Inc., the assignee of the present application, has a number of pending applications covering the monitored dispensing of dispensable items, including application Ser. No. 11/862,347 filed Sep. 27, 2007; Ser. No. 12/361,443 filed Jan. 28, 2009; Ser. No. 12/365,143 filed Feb. 3, 2009; and others. Each of these applications are incorporated herein by reference in their entirety. These co-pending applications describe systems in which dispensable items such as drugs or alcohol are monitored using a monitoring system.

Embodiments include, but are not limited to: a central server database, e.g., controlled and administered by one or more Governmental regulatory agencies, an encryption structure, e.g., a computer running an algorithm for encrypting and coding the prescription, a printer, prescription blanks, a control function to restrict dispensing of certain drugs to certain persons, and a reporting system.

If a doctor or pharmacist attempts to dispense a controlled drug substance to a person who is already under the care of a doctor for the same medication, an alert is formed to inform authorities that the patient is being over medicated. Also, the doctor and or pharmacist will receive notification and an investigation will be conducted to determine if there is any illegal activity by either the doctor or the pharmacist doing the prescribing and dispensing.

It is the intention of this invention to control the distribution, dosages, number of pills or drugs, and the frequency with which certain types of drugs are prescribed and administered. Patients in Hospitals as well as outpatients will all benefit from this system that holds doctors and hospital staff from mis-administering or dispensing as well as abuses of the patients themselves in overdosing, or redistributing various and certain controlled drug substances for a profit, such as Vicodin or Valium.

In recent months the world was shocked at the untimely death of Michael Jackson, a Rock and Roll Legend in the World of Music. The news reports indicated that he had a literal private pharmacy at his home at the time of his death. Expert opinion agrees that his easy access to habit forming drugs and celebrity status contributed to his sudden death.

According to embodiments, the prescription pad the doctor uses is printed out each time the doctor administers a prescription drug to a patient. This printed prescription is encrypted using an encryption system, e.g., an encrypted glyph, that has the patients name, drug prescribed, dosage and doctor's name and registration number graphically embedded in the prescription itself. In one embodiment, the glyph may be formed of individual images, each of which represents one or more letters, and each of which has the same outer shape, with the difference in the encoding represented by the portion of the glyph that is inside the outer shape.

An alternative embodiment may use any kind of image in place of the glyph.

The prescription when presented to the pharmacy for dispensing is inserted into a machine which verifies and authenticates the prescription and other embedded information. The encrypted information is sent to a central server database to log and record the data.

If in the case of Michael Jackson, he has been overprescribed the same drug by various physicians or the same physician, the overprescription would have been marked for further investigation by the State Medical Board or Board of Family Medicine in each State.

An embodiment includes a downloadable computer algorithm for printing the prescription, image and/or encrypted image on a standard computer printer.

At the pharmacy end, a prescription validation unit reads the prescription and glyph. The validation unit can be located at all prescription pharmacies. A central database for logging prescriptions written and dispensed and an oversight committee or Regulatory Board to provide regulation to Doctors and Pharmacists who abuse the system and their patients.

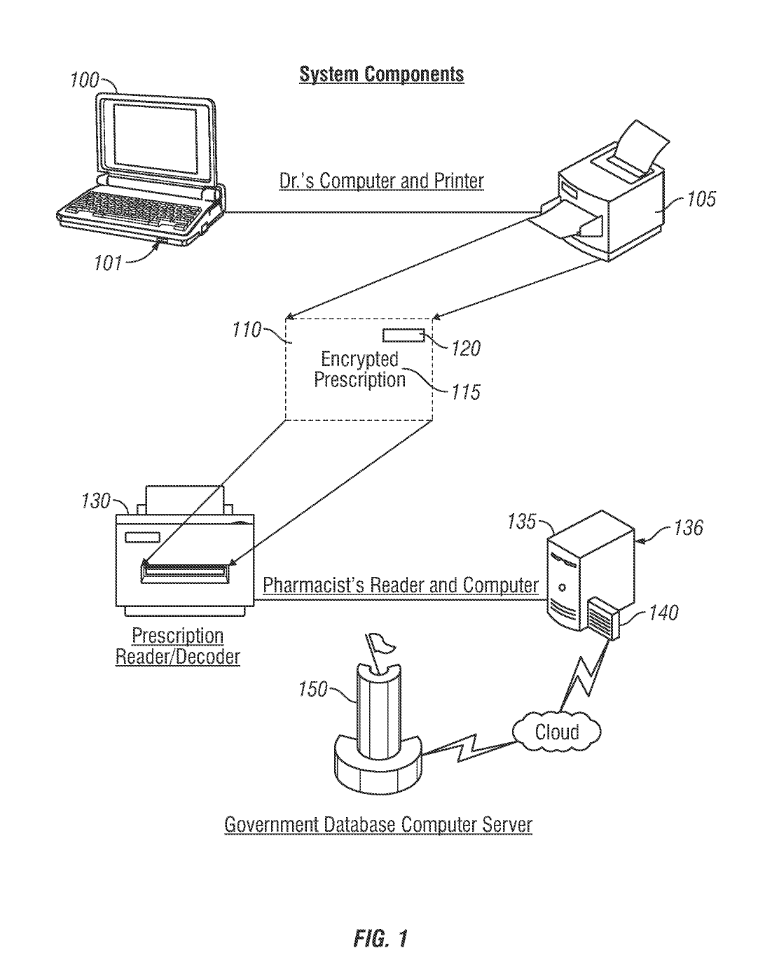

An embodiment of the overall system is shown in FIG. 1. A doctor who writes a prescription does so from the computer 100 which may be a laptop as shown or may be a portable computer such as a tablet computer e.g. an iPad or iPod. The doctor friends the prescription using the printer 105. This uses a special routine shown generically as 101 that is running on the computer. The special routine produces a prescription shown as 110. The prescription 110 includes a written portion 115. In this embodiment, the words on the prescription are “encrypted prescription”. A checksum image 120 is also shown, which represents encrypted information indicative of the encrypted prescription. For example, this encrypted information can be a barcode or any other kind of image that represents the contents of the prescription.

In one embodiment, the security of the system is insured by a password which needs to be entered before the computer program will actually output the prescription. For example, this may require the doctor to enter their personal password each time they want to form a prescription. In one embodiment, that personal password may be verified with a central server prior to allowing the prescription to be created.

The user can take the paper prescription 110 to a pharmacy, and present it, where it is inserted into a prescription reader and decoder 130. In one embodiment, this can be a simple scanner that scans the prescription into the computer 135. The computer 135 may run a routine shown as 136 that carries out the opposite operation to the routine 101. The computer may verify the prescription as read and may also send it over a modem 142 to a central database server 158 which keeps track of all prescriptions from all sources.

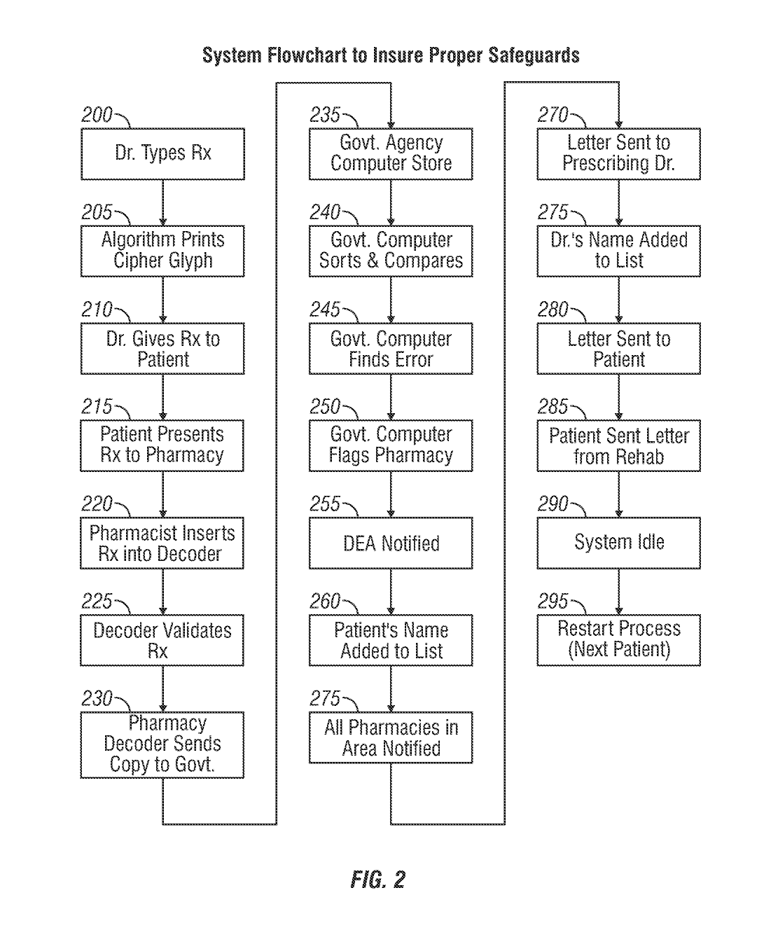

The flowchart of FIG. 2 shows the overall flowchart. At 200, the physician enters a prescription. A routine on the computer prints the prescription along with an encrypted image. In this embodiment, the encypted image is referred to herein as a cipher glyph.

The physician gives this prescription to the patient at 210. Thereafter, the patient presents the prescription to the pharmacy at 215, and the pharmacy inserts the prescription into the decoder 130 at 220. The decoder validates the prescription at 225, using the computer 135. At 230 the pharmacy decoder sends a copy to the government database 150, and the government agency computer 235 stores this at 235 and compares it at 240 with other prescriptions. If the government computer finds an error at 245, it flags the pharmacy 250 that such an error has occurred. For example, the Drug Enforcement Agency (DEA) may be notified at 255 in which case the patient's name is added to a list at 260 and all pharmacies in the area are notified at 265. Continuing with the safeguard routine, a letter is sent to the prescribing doctor at 270 and the prescribing doctor's name is added to a list at 275. In addition, a letter is sent to the patient at 280, and the patient also receives other information such as a letter from a rehab facility. The system then goes idle at 290 and restarts the process at 295 with a new patient.

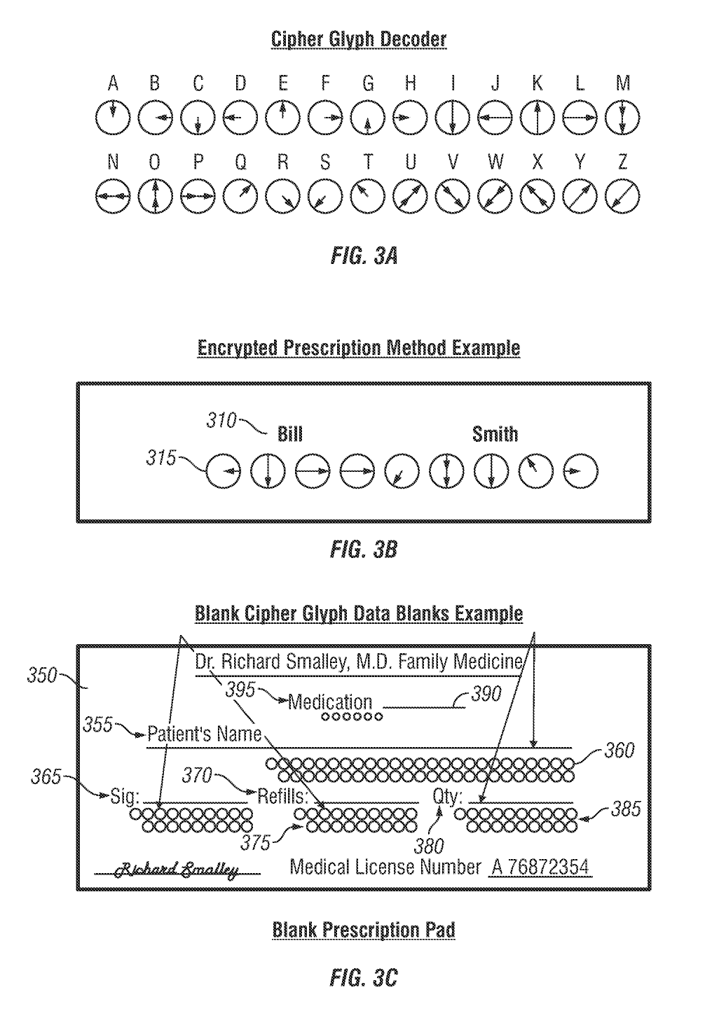

One embodiment of the encrypted prescription may use the glyph system shown in FIG. 3A-3C. The cipher glyph decoder and encoder is shown in FIG. 3A. In this embodiment, each of a number of different letters are represented by a specific glyph. For example, the letter “a” is represented by a downward arrow extending towards the center of a circle. By combining different glyphs in different ways, all of the letters of the alphabet can be represented. An important feature in this embodiment is that each of the glyphs has the same outer shape, here the shape of a circle, and the difference is what is inside the outer shape. This facilitates, as shown in FIG. 3C, that a number of glyphs can be formed where all of the glyphs have the same outer shape. The inner part of the glyph forms the cipher portion that changes between different encoded parts.

While this is not a high security encoding system, this is still sufficient to prevent simple forgery of the prescription.

According to another embodiment, a higher security encryption system can be used, for example, a PGP encryption system.

FIG. 3B shows an example where the patient's name here ‘Bill Smith’ at 310 is encoded into the glyph format at 315. This provides both the patient's name, therefore, and also a glyph representation of the patient's name. FIG. 3C represents the prescription pad. The prescription pad at 350 includes a spot for the patient's name at 355, as well as glyph areas 360 which can encode the patient's name. It also includes a signature line for the doctor at 365 and the number of refills on line 370 along with glyphs representing the number of refills and the quantity 380 and glyphs 385 representing the quantity. A spot for the medication 390 as well as glyphs representing that medication 395 is also shown. According to this embodiment, each of a number of fields on the prescription are shown in plain English, and also shown in glyph form, which can be compared with the plain English.

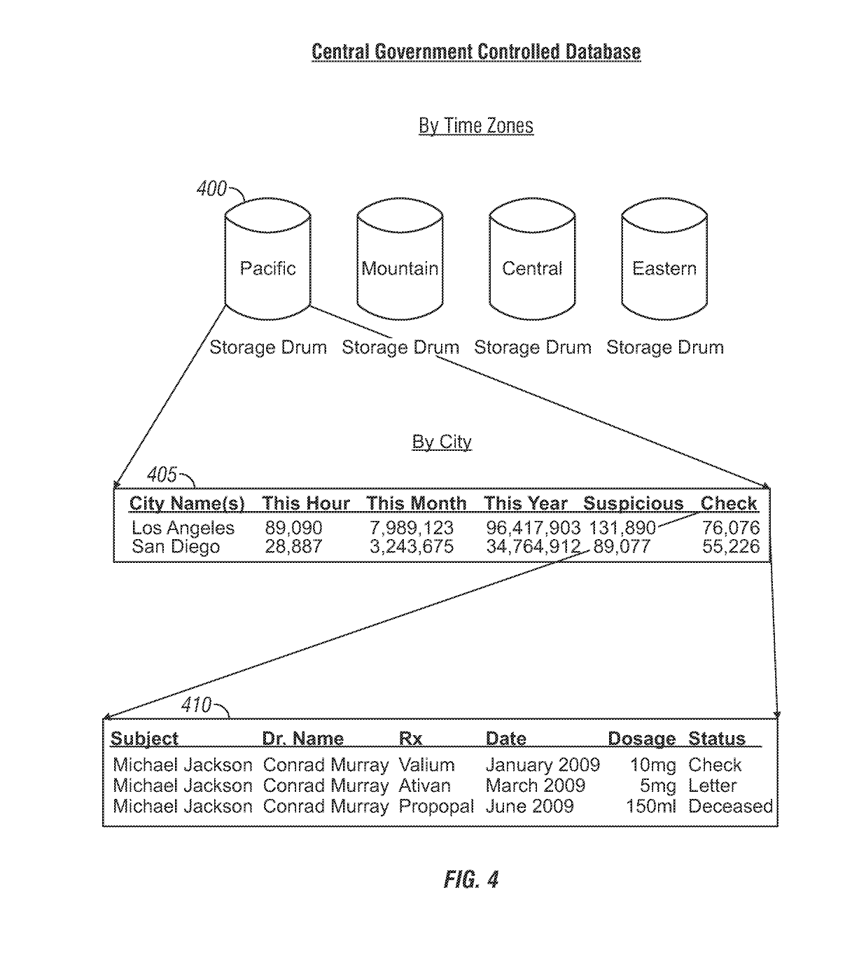

FIG. 4 shows the database that is used by the government or other central determination agency. Each of a plurality of time zones may be separately maintained in the databases. For example the Pacific database 400 may be maintained by city and time. The city of Los Angeles at 405, a number of prescriptions this hour, this month, and/or this year may be maintained, as well as the number of those that are suspicious. These are further broken down at 410 into the patient and doctor name as well as the prescription date dosage and status. The database can correlate among these different dosages and values to determine if the patient has has received too much collectively of any drug, for example, too much of any drug in any one year, even if the drug is prescribed by many different doctors.

If the central database determines that the doctor has been prescribing too many medications of the specified type, a report of the form shown as 500 can be created, indicating the doctor and indicating how many patients have been abused at 505, the substances that the doctor has been prescribing, and other information.

An automatic letter such as 600 may be also sent to the doctor indicating their overprescription of certain substances.

In another embodiment, this can the same system can be used for monitoring the dispensing of alcoholic beverages.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other hardware and software can be used. Moreover, while this describes use with metering of drugs and alcohol, this can also be used for other inventory control purposes such as for dispensing inventory for example in an automated inventory system.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A prescription writing system, comprising:
a computer program, running on a computer, which receives information about a prescription, and information about a patient, and produces a prescription which includes information about the patient, information about medication that is being dispensed by the prescription, and an enciphered image indicative of information including at least said patient name and said medication.

2. A system as in claim 1, wherein said computer program requires a password from a user in order to produce said prescription.

3. A system as in claim 1, wherein said enciphered image includes a plurality of individual glyphs, one glyph for each letter.

4. A system as in claim 3, wherein each of said plurality of glyphs has the same outer shape, and different glyphs have different information inside the outer shape.

5. A system as in claim 4, wherein said different information includes different line segments pointing in different directions.

6. A system as in claim 1, wherein said prescription has a number of different enciphered images, each adjacent one of a plurality of fields on the prescription.

7. A system, comprising:
a prescription reader, which reads a prescription which has been created on a medium, and verifies said prescription by printed and readable information on the prescription and also by reading a coded portion on the prescription on the medium, where verifies determines automatically whether the coded portion on the medium matches with the readable information on the medium, and produces a verification if said coded portion on the medium matches with the readable information on the medium, and automatically sends information indicative of the verification and of the prescription to a remote database.

8. A system as in claim 7, wherein said prescription reader includes a scanner and a computer which receives a result from said scanner.

9. A system as in claim 8, wherein said prescription reader reads words on said prescription as said readable information, and also reads an image on said prescription as said coded information.

10. A system as in claim 9, wherein said image has a single image portion for each of a plurality of letters of the readable image.

11. A system as in claim 9, wherein said image is formed of a number of characters, each character having the same outer shape, and having different inner information inside the outer shape.

12. A system as in claim 11, wherein said outer shape is circular, and the different inner information is information that represents a letter.

13. A system as in claim 12, wherein said different inner information is information that has different length and size for different information.

14. A method, comprising:
in a computer, receiving information about a prescription, and information about a patient;
using said computer to produce a prescription on a medium, said prescription on said medium, including information about the patient, information about medication that is being dispensed by the prescription, and a coded image indicative of information including at least a name of said patient and said medication.

15. A method as in claim 14, further comprising requiring a password from a user in order to produce said prescription on said medium.

16. A method as in claim 14, wherein said coded image includes a plurality of individual glyphs, one glyph for each letter of items on a medium.

17. A method as in claim 16, wherein each of said plurality of glyphs has a same outer shape, and different glyphs have different information inside the outer shape.

18. A method as in claim 17, wherein said different information includes different line segments pointing in different directions.

19. A method as in claim 18, wherein said prescription has a number of different encoded images, each adjacent one of a plurality of fields on the prescription.
